(19) United States
(12) Patent Application Publication
(10) Pub. No.: US 2016/0258628 A1
(43) Pub. Date: Sep. 8, 2016

(54) FUEL NOZZLE CARTRIDGE AND METHOD FOR ASSEMBLY

(71) Applicant: GENERAL ELECTRIC COMPANY, Schenectady, NY (US)

(72) Inventors: Leonid Yulievich GINESSIN, Moscow (RU); Almaz Kamilevich VALEEV, Moscow (RU); Borys Borysovych SHERSHNYOV, Moscow (RU); Andrey Pavlovich SUBBOTA, Moscow (RU)

(73) Assignee: GENERAL ELECTRIC COMPANY, Schenectady, NY (US)

(21) Appl. No.: 15/028,032

(22) PCT Filed: Nov. 22, 2013
(86) PCT No.: PCT/RU2013/001053

§ 371 Date: Apr. 8, 2016

(51) Int. Cl. F23R 3/28; F02C 7/22; F02C 3/04

(52) U.S. Cl. CPC F23R 3/28; F02C 3/04; F02C 7/222; F05D 2220/32; F05D 2240/35

(57) ABSTRACT

A gas turbine system is provided. The gas turbine system includes a combustor assembly. At least one liquid fuel cartridge in the combustor assembly includes at least one flexible tube section coupled within a housing. An elongated inner tube section is coupled in fluid communication with the at least one flexible tube section and oriented within an elongated outer tube extending from the housing. At least one support member oriented within and coupled to an inner surface of the elongated outer tube substantially precludes transverse movement of the elongated inner tube section within the elongated outer tube.

### BACKGROUND

The present disclosure relates generally to turbine engines and, more specifically, to liquid fuel cartridges for turbine engine combustor fuel nozzles.

At least some known turbine engines are configured for use with both gaseous and liquid fuels. More specifically, at least some known turbine engines are configured to combust gaseous fuels under typical operating conditions. However, occasionally conditions may exist during which operation with gaseous fuels may not be possible, due to unavailability of gaseous fuel, for example. Accordingly, combustors in such turbine engines are provided with both gaseous fuel nozzles and liquid fuel cartridges. The combustors may have a can-shaped configuration, with an end cover oriented on a “cold” end of the combustor. The liquid fuel cartridges may be configured for insertion into the combustor via an aperture defined in the end cover. Such liquid fuel cartridges may be referred to as “breach-loaded” liquid fuel cartridges.

The liquid cartridge may include a tip portion, an elongated stem, a body, and a flange configured to couple to fuel, air, and water supplies. In at least some known liquid fuel cartridges, the stem includes an outer tube and at least one inner tube section, such that the outer and at least one inner tube sections terminate at the tip portion. The inner tube section channels liquid fuel from a coupling at the cold end of the combustor to the tip, and the outer tube channels water and/or air to the tip. The liquid fuel enters the at least one inner tube section at a temperature that is approximately ambient temperature. However, the outer tube is exposed to combustion temperatures on the order of 800° F. Because liquid fuel at a substantially lower temperature is flowing through the at least one inner tube section during operation of the turbine engine, a substantial temperature differential may exist between the outer tube and the at least one inner tube section. As a result, the outer tube will be prompted to undergo thermal expansion relative to the at least one inner tube section. In order to prevent damage at the tip caused by stresses from the different expansion rates of the inner and outer tubes, in at least some liquid fuel cartridges, the at least one inner tube section is configured to axially slide within the tip.

However, such a liquid fuel tip configuration may result in wear between the tips of the outer tube, and/or the at least one inner tube section due to turbine engine vibration that may result in relative vibratory movements between the outer tube and the at least one inner tube section, at the tip portion, and/or at one or more locations along the stem.

### BRIEF DESCRIPTION

In one aspect, a method for assembling a liquid fuel cartridge for use in a gas turbine engine is provided. The method includes orienting at least one flexible tube section within a housing. The method also includes coupling the at least one flexible tube section to an elongated inner tube section oriented within an elongated outer tube extending from the housing. The method also includes supporting the elongated inner tube section by at least one support member oriented within and coupled to an inner surface of the elongated outer tube, such that the at least one support member substantially precludes transverse movement of the elongated inner tube section within the elongated outer tube, and such that the elongated inner tube section is axially movable relative to the at least one support member.

In another aspect, a gas turbine system is provided. The gas turbine system includes a compressor section, a combustor assembly coupled to the compressor section, and a turbine section coupled to the compressor section, wherein the combustor assembly includes at least one liquid fuel cartridge. The at least one liquid fuel cartridge includes at least one flexible tube section coupled within a housing. The at least one liquid fuel cartridge also includes an elongated inner tube section coupled in fluid communication with the at least one flexible tube section. The elongated inner tube section is oriented within an elongated outer tube extending from the housing. The at least one support member is oriented within and coupled to an inner surface of the elongated outer tube, such that the at least one support member substantially precludes transverse movement of the elongated inner tube section within the elongated outer tube, and such that the elongated inner tube section is axially movable relative to the at least one support member.

In another aspect, a liquid fuel cartridge assembly for use in a combustor is provided. The liquid fuel cartridge assembly includes at least one flexible tube section coupled within a housing. The liquid fuel cartridge assembly also includes an elongated inner tube section coupled in fluid communication with the at least one flexible tube section, the elongated inner tube section oriented within an elongated outer tube extending from the housing. The liquid fuel cartridge assembly also includes at least one support member oriented within and coupled to an inner surface of the elongated outer tube, such that the at least one support member substantially precludes transverse movement of the elongated inner tube section within the elongated outer tube, and such that the elongated inner tube section is axially movable relative to the at least one support member.

### BRIEF DESCRIPTION OF THE DRAWINGS

FIG. 1 is a block diagram of an exemplary turbine system.

FIG. 2 is a sectional side view of an exemplary combustor for use in the turbine system shown in FIG. 1.

FIG. 3 is a side sectional view of an exemplary known fuel nozzle cartridge.

FIG. 4 is an enlarged view of a tip portion of the fuel nozzle cartridge shown in FIG. 3.

FIG. 5 is a sectional side view of an exemplary fuel nozzle cartridge for use in the combustor shown in FIG. 2.

FIG. 6 is a sectional side view of an alternative fuel nozzle cartridge for use in the combustor shown in FIG. 2.

### DETAILED DESCRIPTION

As used herein, the terms “axial” and “axially” refer to directions and orientations extending substantially parallel to a longitudinal axis of a combustor. It should also be appreciated that the term “fluid” as used herein includes any medium or material that flows, including, but not limited to, liquid fuel, gaseous fuel, and air.

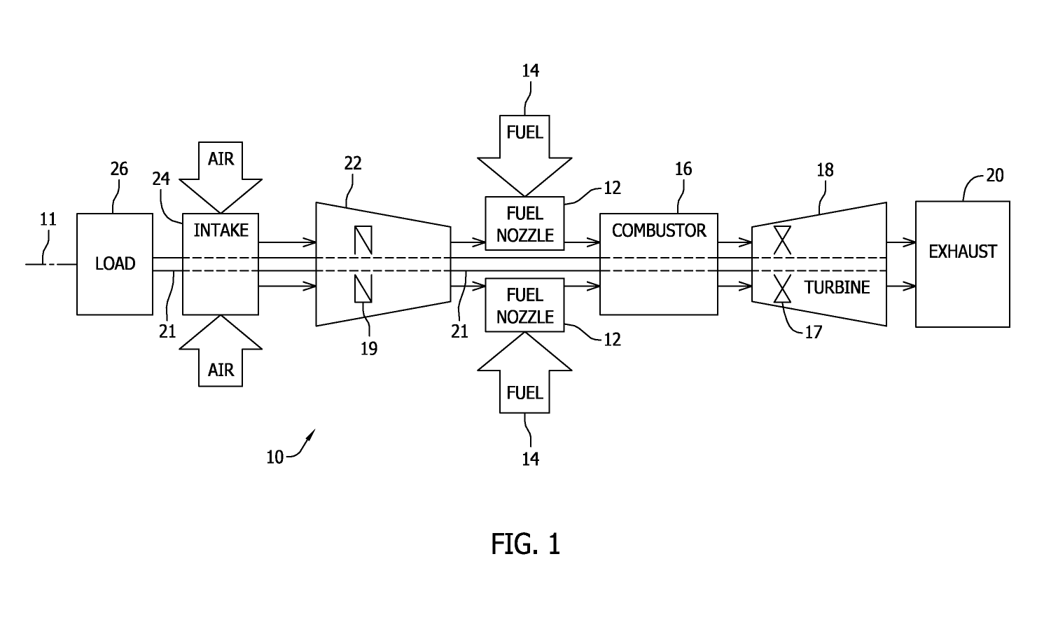

FIG. 1 is a block diagram of an exemplary turbine system 10. Turbine system 10 may use liquid and/or gas fuel, such as natural gas and/or a petroleum-based liquid fuel, such as Naphtha, Petroleum Distillate or a Bio-Fuel. Turbine system 10 includes one or more combustors 16. Each combustor 16 includes a plurality of fuel nozzles 12. Each nozzle 12 receives fuel from a fuel supply 14, mix the fuel with air, and channel an air-fuel mixture into a combustor 16. The air-fuel mixture combusts in a chamber within the combustor 16 to produce hot pressurized exhaust gases. Exhaust gases are channeled from combustor 16 through a turbine section 18 toward an exhaust outlet 20. As the exhaust gases pass through turbine section 18, the gases force a plurality of turbine blades 17 to rotate a shaft 21 along an axis 11 of system 10. As illustrated, shaft 21 is coupled to additional components of turbine system 10, including a compressor 22. Compressor 22 also includes a plurality of blades 19 coupled to shaft 21. Blades 19 within compressor 22 rotate with shaft 21, to compress air channeled into compressor 22 from an air intake 24. Shaft 21 is also coupled to a load 26, which may include, but is not limited to, a vehicle and an electrical generator. In the exemplary embodiment, load 26 may be any suitable device that can be powered by the rotational output of turbine system 10. As described in detail below, fuel nozzle 12 may include a liquid cartridge configured to enable use of liquid fuel to power turbine system 10.

Air enters turbine system 10 via air intake 24 and is pressurized in compressor 22. The compressed air is mixed with fuel within fuel nozzles 12 for combustion within combustor 16. The combustion generates hot pressurized exhaust gases that drive blades 17 within turbine section 18 to rotate shaft 21 to drive compressor 22 and provide rotational power to load 26. More particularly, rotation of turbine blades 17 causes rotation of shaft 21, such that blades 19 within compressor 22 draw in and pressurize ambient air.

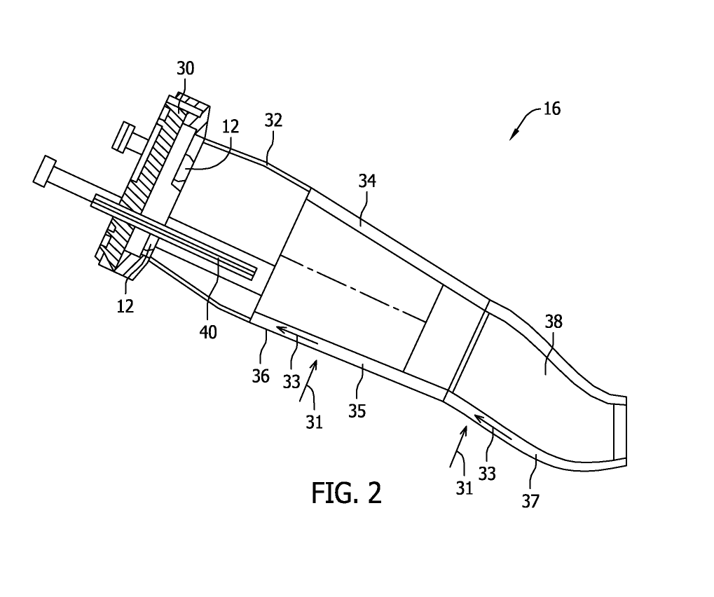

FIG. 2 is a side sectional view of an exemplary combustor 16 for use in turbine system 10 (shown in FIG. 1). A plurality of fuel nozzles 12 is coupled to an end cover 30 of combustor 16. Fuel is channeled through end cover 30 to each fuel nozzle 12. Fuel nozzles 12 channel an air-fuel mixture into combustor 16. Combustor 16 includes a chamber generally defined by a casing 32, a liner 34, and a flow sleeve 36. In the exemplary embodiment, flow sleeve 36 and liner 34 are oriented coaxially with one another to define a hollow annular space 35. Air flow 31 channeled from compressor 22 (shown in FIG. 1) enters hollow annular space 35 through perforations (not shown) in flow sleeve 36, and an annular space 37 in a transition piece 38. Air flow 31 is channeled upstream, along a direction indicated by an arrow 33, toward fuel nozzles 12 to provide cooling of liner 34 prior to entry, via fuel nozzles 12, into a combustion zone within liner 34, wherein combustion of the air-fuel mixture occurs. The resultant exhaust gas is channeled through transition piece 38 to turbine section 18 (shown in FIG. 1), causing blades 17 of turbine section 18 to rotate, along with shaft 21. The air-fuel mixture is burned within combustor 16 at a location downstream of fuel nozzles 12.

In the exemplary embodiment, fuel nozzle 12 includes a liquid fuel cartridge 40 for use in injecting liquid fuel from a supply of liquid fuel (not shown) into combustor 16. In one embodiment, liquid fuel cartridge 40 is provided so that liquid fuel can be used in combustor 16 as a supplement to a fuel gas supplied to fuel nozzle 12, wherein the fuel gas serves as the primary fuel for combustor 16. In addition, liquid fuel cartridge 40 can supply liquid fuel from a fuel reserve (not shown) that is maintained in the event that a supply of fuel gas (not shown) is interrupted or otherwise unavailable. In an alternative embodiment, combustor 16 may use liquid fuel as the primary fuel, channeled by liquid fuel cartridge 40 to fuel nozzle 12.

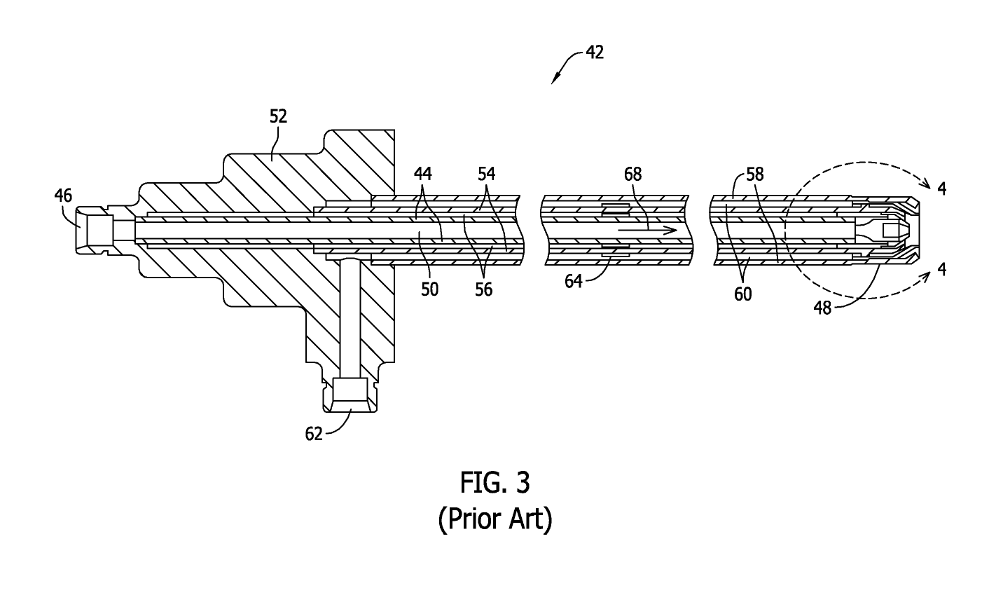

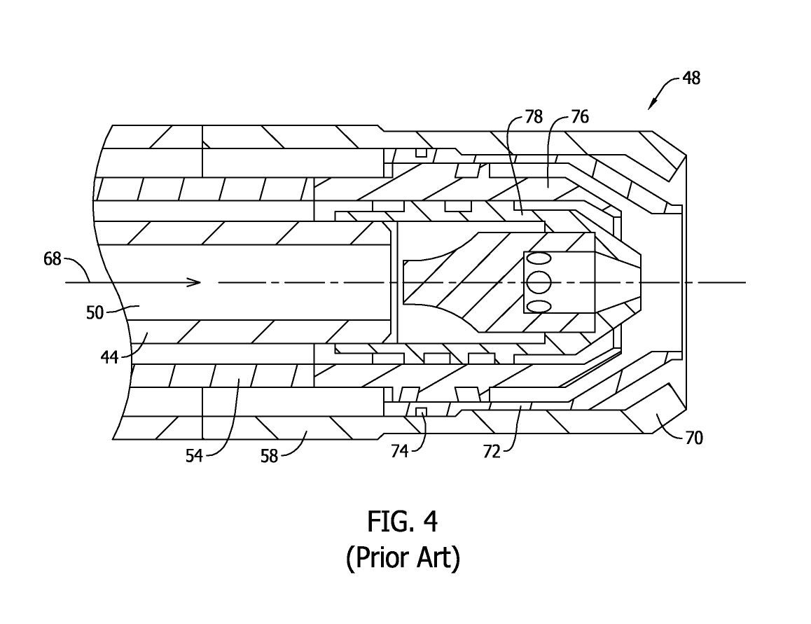

FIGS. 3 and 4 illustrate an exemplary known fuel nozzle cartridge 42. Specifically, FIG. 3 is a sectional side view of an exemplary known fuel nozzle cartridge 42, and FIG. 4 is a detailed sectional side view of a tip portion 48. In the exemplary embodiment, cartridge 42 is referred to as a “breech-loaded” cartridge, in that cartridge 42 is configured to be inserted into combustor 16 from a “cold” side of end cover 30 (shown in FIG. 2). A central fuel tube 44 located within cartridge 42 enables fluid communication of fuel from a fuel inlet 46 to tip portion 48. For example, fuel inlet 46 may be coupled, via hoses or tubes, to a liquid fuel supply (not shown), such as a fuel tank. Any suitable coupling mechanism may be used to couple the fuel hose to fuel inlet 46, including but not limited to threaded couplings, welding, brazing, or other appropriate leak-proof coupling. Fuel flows from fuel inlet 46 through a fuel cavity 50 within the fuel tube 44 to supply a combustor (not shown) with fuel to be mixed with air and water for combustion. Cartridge 42 includes a flange 52 for facilitating coupling of cartridge 42 to combustor 16 (shown in FIG. 2). Flange 52 includes an air inlet 62.

A water tube 54 may be oriented outside of, and concentric to, fuel tube 44. In addition, a water cavity 56, located between water tube 54 and fuel tube 44 enables fluid communication of water from a water inlet (not shown) to tip portion 48, to facilitate injection of water into a combustion zone (not shown) within combustor 16 (shown in FIG. 2). In addition, an air tube 58 may be located outside of, and concentric to, water tube 54. An air cavity 60 may be located between air tube 58 and water tube 54, thereby enabling fluid communication of air from air inlet 62 to tip portion 48 for injection into the combustion zone. Further, air cavity 60 may have standoffs 64 or other structural supports configured to provide structural rigidity and re-enforcement between air tube 58 and water tube 54.

As depicted, the air, water, and fuel may flow in a downstream direction 68 toward tip portion 48 for injection through a fuel nozzle (not shown) into combustor 16 (shown in FIG. 2), thereby enabling combustion to drive the turbine engine 10 (shown in FIG. 1). As illustrated, the air, water, and fuel flows are generally coaxial or concentric with one another due to the coaxial or concentric arrangement of tubes 44, 54, and 58.

Tip portion 48 includes an atomizing air tip 70, which is the exterior of tip portion 48. Further, shroud 72 is fixedly secured to atomizing air tip 70 via a joint 74. Joint 74 may couple the two components via any appropriate mechanism sufficient to block fluid flow. For example, joint 74 may include a braze joint directly between shroud 72 and atomizing air tip 70. Brazed joint 74 may provide a seal to prevent bypass flow between air tip 70 and shroud 72. Tip portion 48 may also include a water tip 76 located coaxially inside shroud 72. In the exemplary embodiment, atomizing air tip 70 and water tip 76 are secured by a weld or other durable coupling technique to air tube 58 and water tube 54, respectively. In addition, a fuel tip 78 may be located coaxially inside water tip 76, wherein fuel tip 78 is configured to enable fluid flow and mixing of the liquid fuel flowing in the downstream direction 68 through fuel tip 78. In the exemplary embodiment, tips 70, 76, and/or 78 are not coupled to each other, and so may be capable of movement relative to each other during operation of turbine 10.

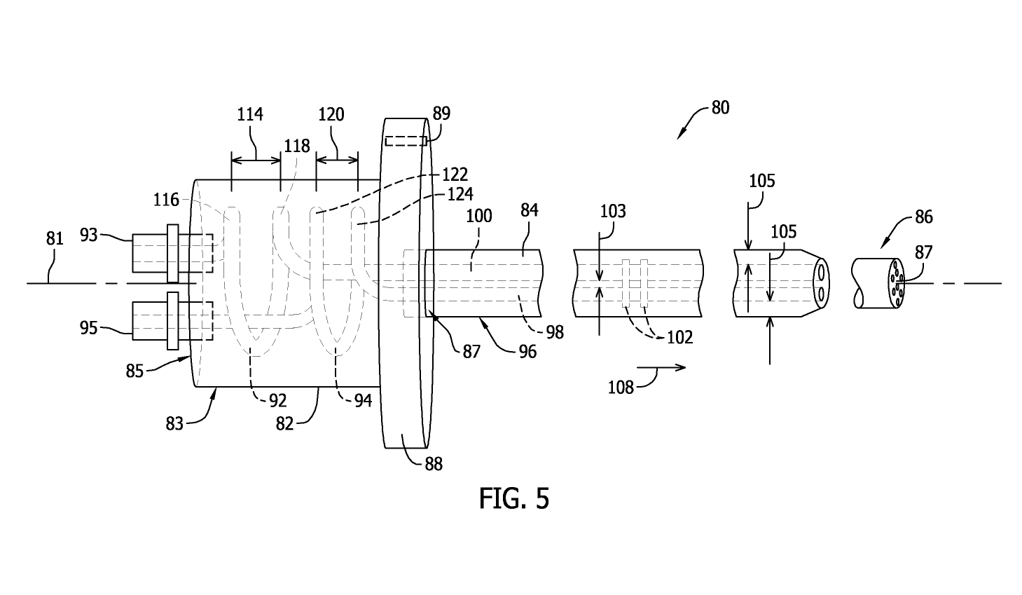

FIG. 5 is a side sectional view of an exemplary liquid fuel cartridge 80 for use in combustor 16 (shown in FIG. 2). Cartridge 80 includes a body 82, a stem 84 extending from body 82, and a tip 86. Stem 84 extends substantially parallel to a longitudinal axis 81. Body 82 includes a housing 83 that is substantially cylindrical in cross-section, and includes an end wall 85 and a coupling flange 88. Stem 84 includes an outer tube 96 that is coupled to flange 88. Cartridge 80 also includes fittings 93, 95, wherein fitting 93 is coupled to a first flexible tube section 92, and fitting 95 is coupled to a second flexible tube section 94. Tube sections 92, 94 extend within housing 83 to flange 88. Tube section 92 is coupled in fluid communication with elongated inner tube section 100, and tube section 94 is coupled in fluid communication with elongated inner tube section 98. In the exemplary embodiment, flexible coiled tube sections 92 and 94 are helically coiled about axis 81. By providing housing 83 with a cylindrical cross-section, axial coiling of flexible tube sections 92 and 94 is facilitated. Coupling flange 88 includes at least one fastener aperture 89 to enable cartridge 80 to be coupled to end cover 30 (shown in FIG. 2), using any suitable fastener that enables cartridge 80 to function as described herein.

In the exemplary embodiment, each tube section 92 and tube section 100 are initially fabricated as a single component, as are tube sections 94 and 98. In an alternative embodiment, tube sections 92 and 94 may be fabricated separately from tube sections 100 and 98, respectively, and subsequently secured together using any suitable coupling method. In the exemplary embodiment, each flexible coiled tube section 92 and 94 may be fabricated from any suitable flexible material that enables cartridge 80 to function as described herein. Moreover, tube sections 92 and 94 may have any cross-sectional configuration, including, but not limited to, a circular cross-sectional configuration, that enables cartridge 80 to function as described herein.

Tube sections 98 and 100 are supported within outer tube 96 by at least two supports 102 coupled to an inside surface of outer tube 96. Supports 102 maintain tube sections 98 and 100 spaced a distance 103 from each other. Supports 102 also maintain tube sections 98 and 100 spaced at least a distance 105 from the inside surface of outer tube 96. More particularly, tube sections 98 and 100 are slidably supported within outer tube 96 by supports 102. Each support 102 may have any configuration that enables cartridge 80 to function as described herein. For example, any number of supports 102 may be provided, that enables cartridge 80, and more specifically, tube sections 98 and 100, to be tuned to address vibrations that may be imposed on tube sections 98 and 100 during operation of turbine system 10. Supports 102 substantially prevent or reduce undesirable transverse vibratory movements of tube sections 98 and 100. In the exemplary embodiment, flange 88 includes at least one aperture 87 through which tube sections 98 and 100 extend to enable tube sections 98 and 100 to be coupled to respective flexible tube sections 94 and 92, such that tube sections 98 and 100 can move axially relative to flange 88.

In the exemplary embodiment, tube sections 98 and 100 terminate at inlet ports (not shown) of tip 86. Tip 86 may have any suitable configuration, including any suitable number and arrangement of apertures 87, that enables tip 86 to discharge a spray of air, fuel, and/or water toward a combustion zone (not shown) within combustor 16 (shown in FIG. 2). Tube sections 98 and 100 are rigidly coupled to tip 86, as is outer tube 96. In general, tip 86 may have any configuration that enables liquid fuel cartridge 80 to function as described herein. For example, tip 86 may be configured as a substantially solid block of material having internal passages (not shown) that are coupled in fluid communication with suitably configured inlets oriented to be coupled to tube sections 98 and 100, and one or more suitably configured outlets as described hereinabove.

During operation of combustor 16 (shown in FIG. 2), when liquid fuel is used, liquid fuel is supplied to at least one of fittings 93, 95 from a source (not shown) of liquid fuel at ambient temperature, for example 75° F. However, outer tube 96 is exposed to compressed air temperatures, for example, about 800° F. Inner tube sections 98 and 100, having ambient temperature liquid fuel channeled through them, remain at a substantially lower temperature than outer tube 96. As a result, outer tube 96 undergoes a larger thermal expansion in a direction indicated by an arrow 108 than do inner tube sections 98 and 100. Because inner tube sections 98 and 100 are rigidly coupled to tip 86, tube sections 98 and 100 likewise will experience tension forces in the direction of arrow 108, for example, if tube sections 98 and 100 are fabricated from the same or similar material as each other and/or as that of outer tube 96. As tube sections 98 and 100 move axially relative to supports 102 and flange 88, coiled tube sections 92 and 94 accommodate the movement of tube sections 98 and 100 by, amongst other changes in configuration, stretching in the direction indicated by arrow 108, for example, such that a distance 114 between adjacent loops 116 and 118 of tube section 92 increases, as does a distance 120 between adjacent loops 122 and 124 of tube section 94. As a result, tension forces that might otherwise be imposed on tube sections 98 and 100, and, more specifically, to their connections to tip 86, are avoided.

In the exemplary embodiment, after liquid fuel combustion is terminated, cartridge 80 is flushed by channeling a flushing fluid, including but not limited to water, through cartridge 80. Flushing of cartridge 80 prevents coking of residual liquid fuel remaining in cartridge 80 during continued operation of combustor 16 (shown in FIG. 1) using gaseous fuel. In addition, flexible tube sections 92 and 94, and respective elongated inner tube sections 100 and 98 provide smooth continuous flow paths for liquid fuel, and for flushing fluids used to flush cartridge 80 after liquid fuel combustion is terminated, such that coking of residual liquid fuel is reduced or avoided.

As described hereinabove with respect to FIGS. 3 and 4, at least some known injectors include tips in which radially and outer tube sections can move axially and/or laterally relative to one another. In the exemplary embodiment of FIG. 5, by rigidly coupling tube sections 98 and 100 to tip 86, potential wear to tip 86 that might otherwise be caused by relative movement between tube sections 98 and/or 100, and tip 86, is avoided.

The exemplary embodiment of FIG. 5 is described as configured to inject fuel and air into combustor 16 (shown in FIG. 2). In an alternative embodiment, cartridge 80 may be configured to spray a liquid fuel-water mixture or emulsion through tip 86. In such an alternative embodiment, a water flows may channeled to one of fittings 93 and/or 95. In another embodiment, an additional passage (not shown) may be provided in cartridge 80 that is coupled to a tube (not shown) having a flexible portion and an elongated portion, that terminates in tip 86, to facilitate mixing of air, fuel and water flows upon discharge from tip 86.

In an alternative embodiment, cartridge 80 may include a single fitting (not shown) that includes two passages coupled in fluid communication, to tube sections 92 and 94, instead of fittings 93 and 95 as shown in FIG. 5. Moreover, in an alternative embodiment, tube sections 98, 100 may be oriented concentrically, instead of parallel and spaced a distance from each other. Furthermore, in an alternative embodiment, tip 86 may have any configuration that enables cartridge 80 to function as described herein.

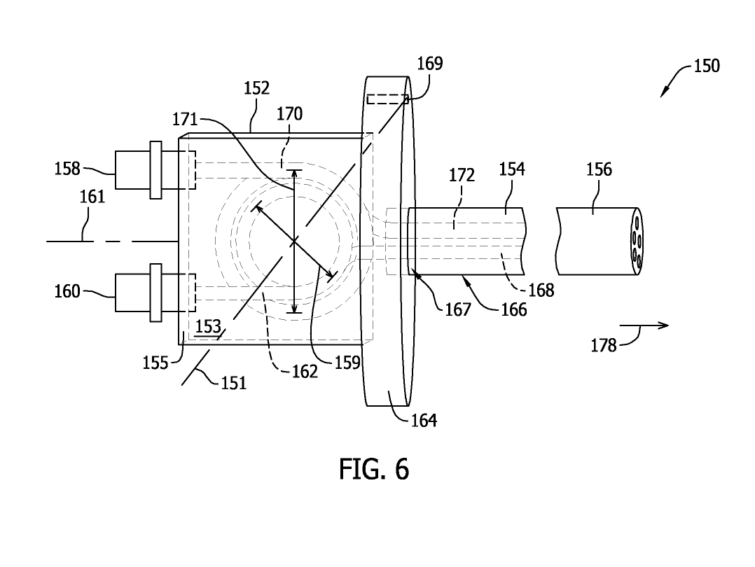

FIG. 6 is a side sectional view of an alternative liquid fuel cartridge 150 for use in combustor 16 (shown in FIG. 2). Cartridge 150 includes a body 152, a stem 154 extending from body 152, and a tip 156. Stem 154 extends substantially parallel to a longitudinal axis 161. Body 152 includes a housing 153 that has an end wall 155 and a coupling flange 164. In the exemplary embodiment, housing 153 is substantially rectangular in cross-section. Stem 154 includes an outer tube 166 that is coupled to flange 164 via an aperture 167 in flange 164. Cartridge 150 also includes a first liquid fuel fitting 158 and a second liquid fuel fitting 160, wherein fittings 158 and 160 are coupled adjacent to respective apertures (not shown) in end wall 155. A first flexible tube section 170 is coupled to fitting 158, and a second flexible tube section 162 is coupled to fitting 160. Tube sections 162, 170 extend from within housing 153 to flange 164. Tube section 162 is coupled in fluid communication with an elongated inner tube section 168, and tube section 172 is coupled in fluid communication with an elongated inner tube section 172. Coupling flange 164 includes at least one fastener aperture 169 to enable cartridge 150 to be coupled to end cover 30 (shown in FIG. 2), using any suitable fastener that enables cartridge 150 to function as described herein.

In the exemplary embodiment, each tube section 162 and tube section 168 are initially fabricated as a single component, as are tube sections 170 and 172. In an alternative embodiment, tube sections 162 and 170 may be fabricated separately from tube sections 168 and 172, respectively, and subsequently secured together using any suitable coupling method. In the exemplary embodiment, each flexible coiled tube sections 162 and 170 may be fabricated from any suitable flexible material that enables cartridge 150 to function as described herein. Moreover, tube sections 162 and 170 may have any cross-sectional configuration, including, but not limited to, one of an oval cross-sectional configuration and a rectangular cross-sectional configuration, that enables cartridge 150 to function as described herein. In the exemplary embodiment, tube sections 162 and 170 are coiled about an axis 151 that extends substantially perpendicular to longitudinal axis 161. Accordingly, tube sections 162 and 170 may be referred to as being “laterally” coiled, relative to body 152.

In the exemplary embodiment, stem 154 has a configuration that may be substantially identical to that of stem 84 shown in FIG. 5. More specifically, tube sections 172 and 168 may be supported within outer tube 166 using one or more supports (not shown), that are similar to supports 102 shown in FIG. 5. In the exemplary embodiment, tip 156 may have any suitable configuration that enables liquid fuel cartridge 150 to function as described herein. Moreover, the use and operation of cartridge 150 is substantially similar to that of cartridge 80, except that to accommodate thermally-induced dimensional changes in tube sections 168 and 172 along a direction 178, tube sections 162 and 170 may undergo more complex configuration changes, which include a reduction in diameter, e.g., diameter 171 of tube section 170, and diameter 159 of tube section 162. In the exemplary embodiment, cartridge 150 may include any number of flexible tube sections and/or elongated inner tube sections that enables cartridge 150 to function as described herein.

In an alternative embodiment, cartridge 150 may include a single fitting (not shown) that includes two passages coupled in fluid communication, to tube sections 162, 170, instead of fittings 158 and 160 as shown in FIG. 5. Moreover, in an alternative embodiment, tube sections 162, 170 may be oriented concentrically, instead of parallel and spaced a distance from each other. Furthermore, in an alternative embodiment, tip 156 may have any configuration that enables cartridge 150 to function as described herein.

The invention described herein provides several advantages over known systems and methods for assembling liquid fuel cartridges for use in combustors for gas turbine engines. Specifically, the systems and methods described herein facilitate accommodating differences in thermal expansion between an outer tube of a liquid fuel cartridge and at least one elongated inner tube section oriented within the outer tube. The systems and methods described herein prevent or reduce wear to a tip of a liquid fuel cartridge that may arise from relative axial movement between the outer tube and the at least one elongated inner tube section oriented within the outer tube. In addition, the systems and methods described herein prevent or reduce undesirable transverse vibratory movement of the at least one inner tube section relative to the outer tube. The systems and methods described herein also provide smooth continuous fluid flow paths within the liquid fuel cartridge that facilitate flushing of residual liquid fuel from the cartridge.

Exemplary embodiments of fuel nozzle cartridges and methods for assembling same are described above in detail. The systems and methods are not limited to the specific embodiments described herein, but rather, actions of the methods and/or components of the systems may be utilized independently and separately from other components and/or actions described herein. For example, the systems and methods described herein are not limited to practice only with combustors for gas turbine engines, but also may be used in combination with other devices that incorporate combustors. Moreover, the exemplary embodiment may be implemented and utilized in connection with many other rotary machine applications, other than gas turbines.

The systems and methods are not limited to the specific embodiments described herein, but rather, operations of the methods and/or components of the systems may be utilized independently and separately from other components and/or actions described herein. The method operations described herein are just examples. There may be many variations to the operations described therein without departing from the spirit of the disclosure. For instance, except as specifically described, the actions may be performed in a differing order, or actions may be added, deleted or modified. All of these variations are considered a part of the claimed invention.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the systems and methods described herein, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the disclosure has been described in terms of various specific embodiments, those skilled in the art will recognize that the disclosure may be practiced with modification within the spirit and scope of the claims.

What is claimed is:

1. A method for assembling a liquid fuel cartridge for use in a gas turbine engine, said method comprising:
orienting at least one flexible tube section within a housing;
coupling the at least one flexible tube section to an elongated inner tube section oriented within an elongated outer tube extending from the housing; and
supporting the elongated inner tube section by at least one support member oriented within and coupled to an inner surface of the elongated outer tube, such that the at least one support member substantially precludes transverse movement of the elongated inner tube section within the elongated outer tube, and such that the elongated inner tube section is axially movable relative to the at least one support member.

2. The method in accordance with claim 1, wherein said method further comprises coupling the at least one flexible tube section in fluid communication with at least one fitting oriented on the housing.

3. The method in accordance with claim 1, wherein said method further comprises coupling the at least one flexible tube section in fluid communication with at least one aperture defined on a tip oriented on the elongated outer tube.

4. The method in accordance with claim 1, wherein said method further comprises defining the at least one flexible tube section as a coil substantially encircling an axis oriented transversely to a longitudinal axis of the elongated outer tube.

5. The method in accordance with claim 1, wherein said method further comprises defining the at least one flexible tube section as a coil substantially encircling a longitudinal axis of the elongated outer tube.

6. The method in accordance with claim 1, wherein said method further comprises orienting the tip, the elongated outer tube and the at least one inner tube section to extend substantially parallel to a common longitudinal axis.

7. The method in accordance with claim 1, wherein orienting at least one flexible tube section further comprises orienting at least two flexible tube sections within the housing.

8. A gas turbine system, said system comprising:
a compressor section;
a combustor assembly coupled to said compressor section; and
a turbine section coupled to said compressor section, wherein said combustor assembly includes at least one liquid fuel cartridge comprising:
at least one flexible tube section coupled within a housing;
an elongated inner tube section coupled in fluid communication with said at least one flexible tube section, said elongated inner tube section oriented within an elongated outer tube extending from said housing; and
at least one support member oriented within and coupled to an inner surface of said elongated outer tube, such that said at least one support member substantially precludes transverse movement of said elongated inner tube section within said elongated outer tube, and such that said elongated inner tube section is axially movable relative to said at least one support member.

9. The gas turbine system in accordance with claim 8, wherein said at least one liquid fuel cartridge further comprises at least one fitting oriented on said housing and coupled in fluid communication with said at least one flexible tube section.

10. The gas turbine system in accordance with claim 8, wherein said at least one liquid fuel cartridge further comprises a tip oriented on said elongated outer tube.

11. The gas turbine system in accordance with claim 8, wherein said at least one flexible tube section is configured as a coil substantially encircling an axis oriented transversely to a longitudinal axis of said elongated outer tube.

12. The gas turbine system in accordance with claim 8, wherein said at least one flexible tube section is configured as a coil substantially encircling a longitudinal axis of said elongated outer tube.

13. The gas turbine system in accordance with claim 8, wherein said tip, said elongated outer tube and said at least one inner tube section extend substantially parallel to a common longitudinal axis.

14. The gas turbine system in accordance with claim 8, wherein said at least one flexible tube section comprises at least two flexible tube sections oriented within said housing, wherein each flexible tube section is coupled in fluid communication with a fitting oriented on said housing.

15. The gas turbine system in accordance with claim 14, wherein each flexible tube section is coupled to an elongated inner tube section.

16. The gas turbine system in accordance with claim 15, wherein said each elongated inner tube section is coupled to at least one aperture defined on a tip coupled to said elongated outer tube.

17. The gas turbine system in accordance with claim 16, wherein said tip further comprises a plurality of apertures within the tip, wherein flows discharged from the elongated inner tube sections are combined prior to discharge from the tip.

18. A liquid fuel cartridge assembly for use in a combustor, said liquid fuel cartridge assembly comprising:
at least one flexible tube section coupled within a housing;
an elongated inner tube section coupled in fluid communication with said at least one flexible tube section, said elongated inner tube section oriented within an elongated outer tube extending from said housing; and
at least one support member oriented within and coupled to an inner surface of said elongated outer tube, such that said at least one support member substantially precludes transverse movement of said elongated inner tube section within said elongated outer tube, and such that said elongated inner tube section is axially movable relative to said at least one support member.

19. The liquid fuel cartridge assembly in accordance with claim 18, wherein said at least one liquid fuel cartridge assembly further comprises at least one fitting oriented on said housing and coupled in fluid communication with said at least one flexible tube section.

20. The liquid fuel cartridge assembly in accordance with claim 18, wherein said at least one liquid fuel cartridge assembly further comprises a tip oriented on said elongated outer tube.
